(19) United States
(12) Patent Application Publication
(10) Pub. No.: US 2011/0143595 A1
(43) Pub. Date: Jun. 16, 2011

(54) Electrical Connection

(75) Inventors: Danilo Facco, Vigodarzere (IT); Francesco Artuso, Albignasego (IT); Moreno Franco, Padova (IT)

(73) Assignee: VIEMME S.R.L., Limena, PD (IT)

(21) Appl. No.: 12/867,870

(22) PCT Filed: Feb. 26, 2009
(86) PCT No.: PCT/EP09/52308

§ 371 Date: Jan. 14, 2011

(30) Foreign Application Priority Data
Feb. 28, 2008 (IT) VI2008U000006

(51) Int. Cl. H01R 13/46; H01R 4/28

(52) U.S. Cl. 439/625; 439/754

(57) ABSTRACT

The invention is an electrical connection (1; 20; 30; 40; 50; 70; 90) comprising a clamp (2) provided with means (3) for fastening to the terminal (P) of an electric accumulator; one or more electric wires (C) that connect the clamp (2) to one or more functions; means (5) for joining each electric wire (C) to the clamp (2). Each joining means (5) comprises: a male connector element (7; 37; 47; 57; 67; 87; 97) and a female connector element (8; 38; 48; 58; 68; 88; 98) which are coupled to each other through contact means (9; 39; 49; 59; 69) with quick pressure coupling and release mechanism.

The invention concerns an electrical connection of improved type.

In particular, the connection concerns the field of electric wiring and is used especially to connect electrical equipment and devices to the clamps of electric accumulators of the static type, for starting or traction purposes.

It is known that in order to connect electrical equipment and devices to electric accumulators special connections are used which are formed by one or more wires connected to each terminal of the accumulator by means of a clamp.

In this way, for example, in the starting electric accumulators installed on cars, special clamps are used to connect the negative terminal of the accumulator to an earth wire that is connected to the body of the vehicle and the positive terminal to one or more electric wires that feed the starter and possibly also other functions of the vehicle.

As far as the above mentioned clamps are concerned, according to some embodiments of the invention they are provided with screw/nut tightening means that serve to fix them to the corresponding terminal of the accumulator and with deformable clips for connection to the wire or wires that feed the various functions of the vehicle.

The connections of this type, however, pose a drawback represented by the fact that in order to disconnect the wires from the accumulator it is necessary to remove the clamp from the terminal through the intervention of the operator who, using apposite tools, loosens the screw means that lock the clamp on the terminal.

This operation, if repeated, may damage the clamp and in some cases also the terminal of the accumulator, if the presence of oxidation obliges the operator to force the connection mechanically.

In order to eliminate these drawbacks, some connections use clamps provided with screw/nut tightening means also for the wires.

These connections, therefore, do not require the removal of the clamp from the accumulator terminal to disconnect the wire, but also in this case the operator has to use apposite tools to loosen the nuts and screws that connect each wire to the corresponding clamp.

Furthermore, the presence of several screws and nuts on the clamp makes it more expensive to manufacture.

Embodiments of the invention are also known, where in order to allow the wires to be connected and disconnected more rapidly, the clamp is provided with a lever locking device for connection to the accumulator terminal.

These embodiments, however, pose a drawback represented by the fact that the effort to be exerted on the lever to tighten or loosen the clamp is rather high, since the length of the lever is generally limited.

Therefore, the operator is often forced to use grip means to increase the lever arm and thus be able to comfortably tighten or loosen the connection. This means that during the tightening and loosening operations the clamp in frequently becomes deformed.

The object of the present invention is to overcome all the drawbacks described.

In particular, it is an object of the invention to carry out an electrical connection suited to connect electric wires to the terminals of an accumulator by means of a clamp, wherein the connection and disconnection of the wires to/from the terminals can be carried out with no need to use special tools.

It is a further object of the invention to ensure that the wires can be disconnected with no need to disconnect the clamp.

It is a further object of the invention to ensure that the connection and disconnection of the wire or wires to/from the terminals can be carried out more rapidly compared to the connections of known type.

It is another object of the invention to ensure that the connection and disconnection of the wires to/from the terminals requires a limited force, approximately ten Newtons, which can be easily exerted by any person.

It is a further, yet not the least object of the invention to ensure that the connection and disconnection can be carried out rapidly.

The objects mentioned above are achieved by an electrical connection having the characteristics described in the main claim.

Further details of the connection are described in the dependent claims.

Advantageously, the electrical connection that is the subject of the invention makes the connection of the electric wires to the terminals of the accumulator simpler and quicker.

In particular, the possibility to rapidly disconnect the wires from the terminals advantageously increases the safety of the connection in case of emergency. Furthermore, advantageously, any damage to the connection can thus be avoided.

Still advantageously, the reduced effort required for the insertion makes the connection particularly easy to be used by any operator, even if he/she is not an expert.

The objects and advantages described above will be highlighted in greater detail here below, with reference to the attached drawings, wherein:

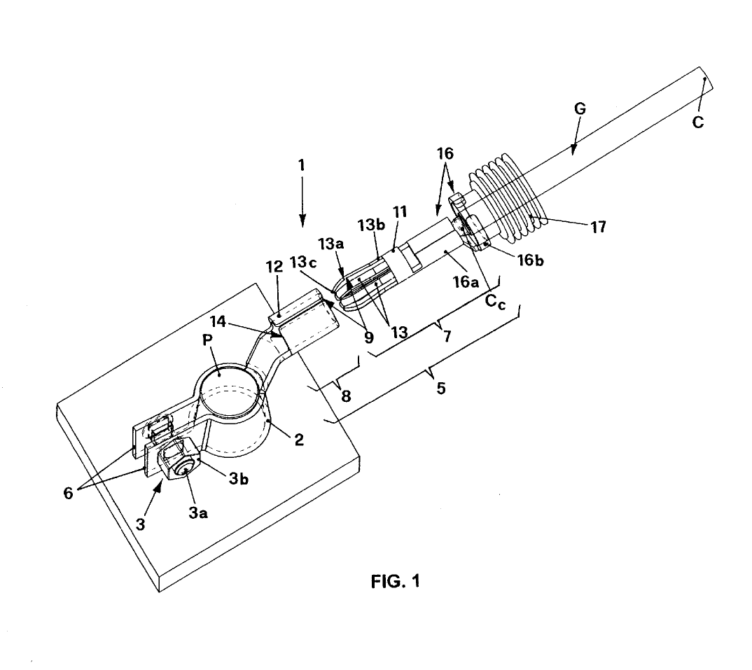

FIG. 1 shows an axonometric view of the connection that is the subject of the invention;

Figures from 2 to 4 show side views of the connection shown in FIG. 1, in three different steps of the coupling operation;

Figures from 5 to 14 show further construction variants of the connection that is the subject of the invention.

The electrical connection that is the subject of the invention is shown in axonometric view in FIG. 1, where it is indicated as a whole by 1.

It can be noted that it comprises a clamp 2 provided with means 3 for fastening to the terminal P of an electric accumulator and joining means, indicated as a whole by 5, for connection to an electric wire C that connects the clamp 2 to a function.

The clamp 2 is substantially C-shaped and is provided with projecting tabs 6 featuring flat parallel surfaces and through holes for the insertion of the fastening means 3 that are constituted by a screw 3a which passes through the above mentioned holes and which is associated with a nut 3b.

The tightening of the nut 3b on the screw 3a after the application of the C-shaped part of the clamp 2 to the outside the terminal P makes it possible to lock the clamp 2.

As far as the electric wire C is concerned, it is connected to a function which may be an electrical device, for example an electric starter, or the body of the car on which the accumulator is installed.

According to the invention, the joining means 5 between the electric wire C and the clamp 2 comprise a male connector element 7 and a female connector element 8 that are coupled via contact means 9 with quick coupling and release mechanism.

As shown in the figures from 2 to 4, the male connector element 7, the female connector element 8 and the contact means 9 with quick coupling and release mechanism are coaxial with one another when they are coupled together.

In particular, the male connector element 7 comprises a shaped core 11 and the female connector element 8 comprises a tubular body 12 that can be coupled through the above mentioned contact means 9.

Said contact means 9 comprise a plurality of elastic tabs 13 with curved profile created in the shaped core 11 and the inner surface 14 of the tubular body 12 that oppose each other in order to guarantee electrical continuity and the mechanical connection between the male connector element 7 and the female connector element 8.

The elastic tabs 13 are parallel to one another and are arranged circumferentially with respect to the longitudinal axis X defined by the shaped core 11 and the curved profile of each one of them has its convex part 13a facing towards the outside of the shaped core 11 to which it belongs in such a way as to be placed in contact with the inner surface 14 of the tubular body 12. Furthermore, each elastic tab 13 has one end 13b that belongs to the shaped core 11 while the opposite end 13c is free, so that each tab 13 behaves like a beam that is constrained at the end 13b and free at the end 13c, which yields elastically at the moment of connection with the corresponding tubular body 12.

The curved profile of the elastic tabs 13, being created at the level of their free end 13c, produces in the shaped core 11 a tapered end 11a that favours its insertion in the tubular body 12 at the moment of coupling.

As regards the male connector element 7, it can be noted that it is provided with deformable clips 16 comprising first deformable clips 16a for connection to the conductive core Cc of the wire C and second deformable clips 16b for connection to a sleeve 17 arranged outside the insulating sheath G that covers the wire C.

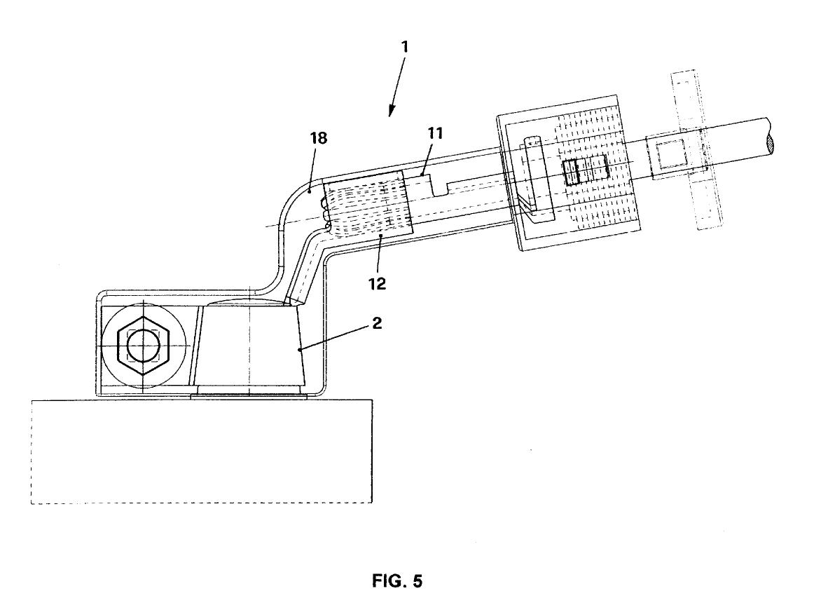

The electrical connection that is the subject of the invention preferably but not necessarily comprises also a covering 18 made of an insulating material and visible in FIG. 5, which serves to protect the clamp 2 as well as the male connector element 7 and the female connector element 8.

The sleeve 17 is coupled within the covering 18, thus carrying out a labyrinth seal against the penetration of liquid or solid matter.

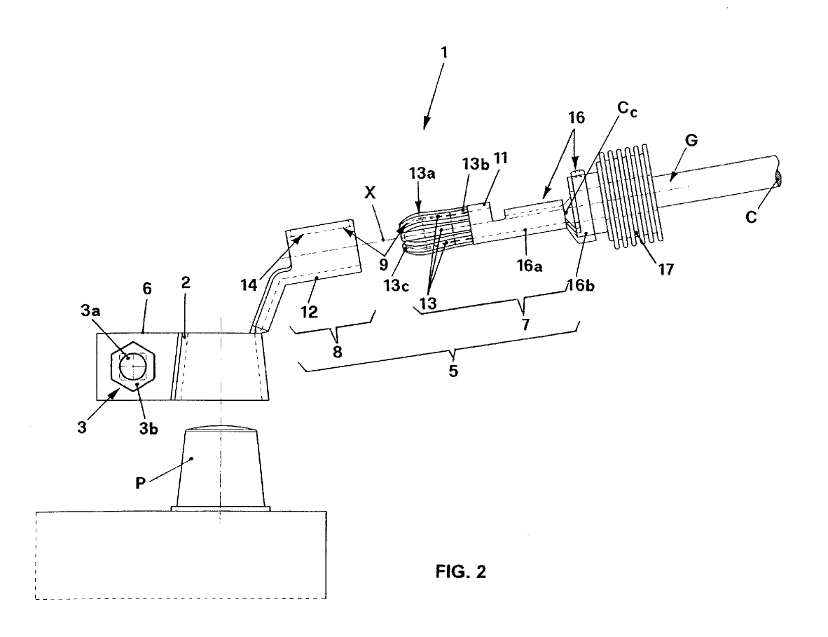

Operatively, with reference to Figures from 2 to 4, to connect the wire C to the clamp 2 and thus to the terminal P of the accumulator, the male connection element 7 is arranged in such a way as to be aligned and coaxial with the female element 8 and spaced from it as shown in FIG. 2.

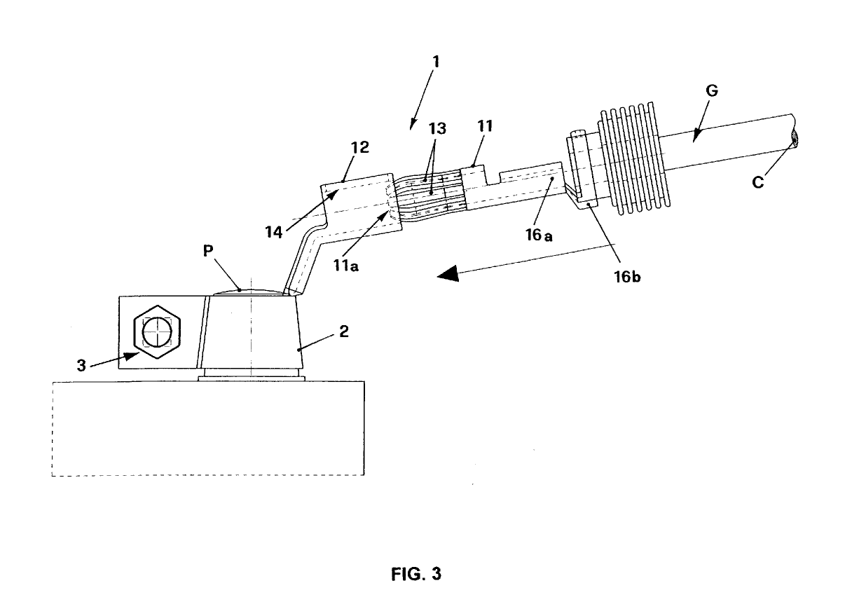

The male connector element 7 is then moved close to the female connector element 8, as shown in FIG. 3, and the shaped core 11 is forced axially against the tubular body 12.

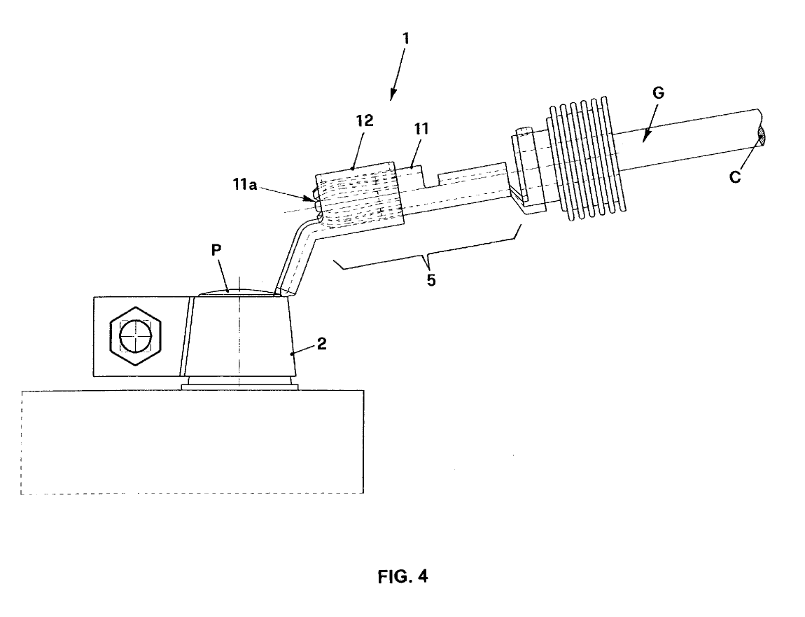

If the axial force exerted is sufficient to overcome the elasticity of the elastic tabs 13, these contract towards the centre and, moving radially close to each other, they allow the shaped core 11 to be fitted in the tubular body 12 as shown in FIG. 4.

The tapered end 11a of the shaped core 11 favours the coupling operation.

Once the coupling has taken place, the spontaneous elastic recovery of the tabs 13 causes them to be thrusted against the inner surface 14 of the tubular body 12, thus ensuring electrical continuity and the mechanical connection.

It is thus clear that the coupling takes place easily and rapidly owing to the simple mutual axial thrust of the connector elements 7 and 8 induced by the operator.

Obviously, the disconnection of the connector elements 7 and 8 is also very easy and is achieved by subjecting the male connector element 7 to a traction force that disconnects it from the female connector element 8.

Therefore, it is not necessary to use special tools and any damage to the clamp or the accumulator terminal or both of them is avoided.

Furthermore, the coupling and uncoupling operations are very rapid and easy, and they can be carried out even by not specialised personnel.

In the construction form described and represented in Figures from 1 to 4, the male connector element 7 belongs to the wire C and the female connector element 8 belongs to the clamp 2.

It is evident, however, that in different embodiments of the invention the male connector element 7 may belong to the clamp 2 and the female connector element 8 may belong to the wire C.

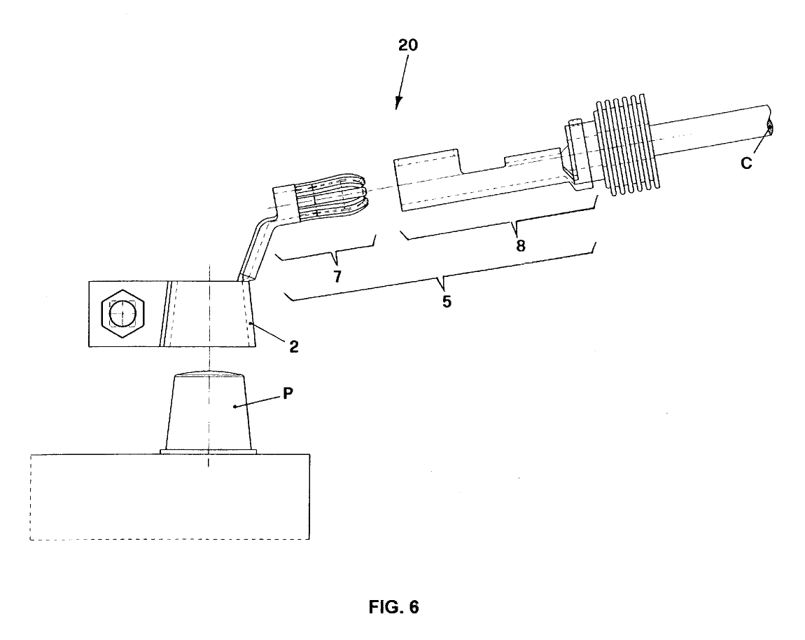

In this regard, a construction variant based on the same idea of solution is shown in FIG. 6, where it can be observed that the connection, indicated as a whole by 20, differs from the connection just described above only in that the male connector element 7 belongs to the clamp 2 while the female connector element 8 belongs to the wire C.

Even in this construction variant the connection and disconnection of the male element 7 to/from the female element 8 take place as described above.

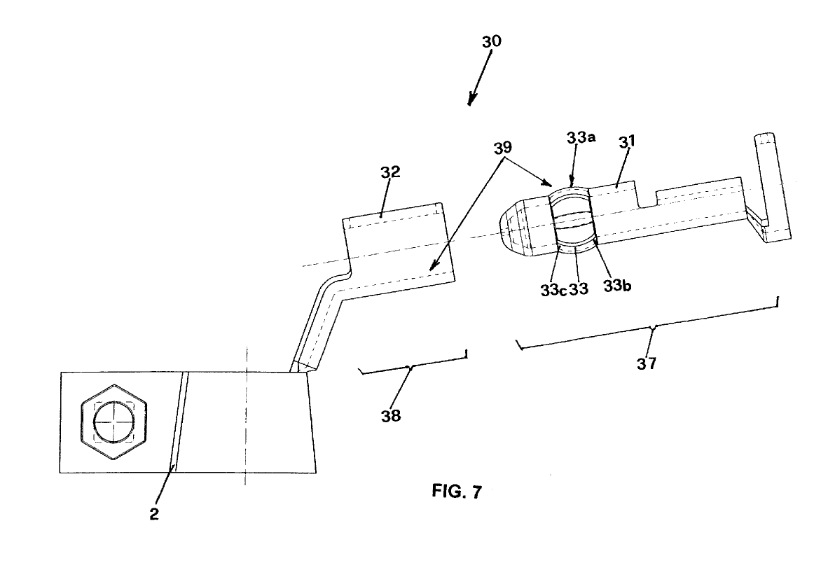

A further construction variant of the connection that is the subject of the invention is shown in FIG. 7, where it is indicated as a whole by 30 and differs from the connection, just described due to a different configuration of the contact means 39.

It can be observed, in fact, that the elastic tabs 33 created in the shaped core 31 of the male connector element 37 have both ends 33b, 33c belonging to the shaped core 31 and the convex part 33a arranged in a substantially central position and facing outwards.

From a static point of view, the elastic tabs 33 behave like a beam constrained at the ends and curved in the central part which during the pressure coupling with the corresponding tubular body 32 of the female connector element 38 becomes elastically deformed and ensures electrical continuity and the mechanical contact.

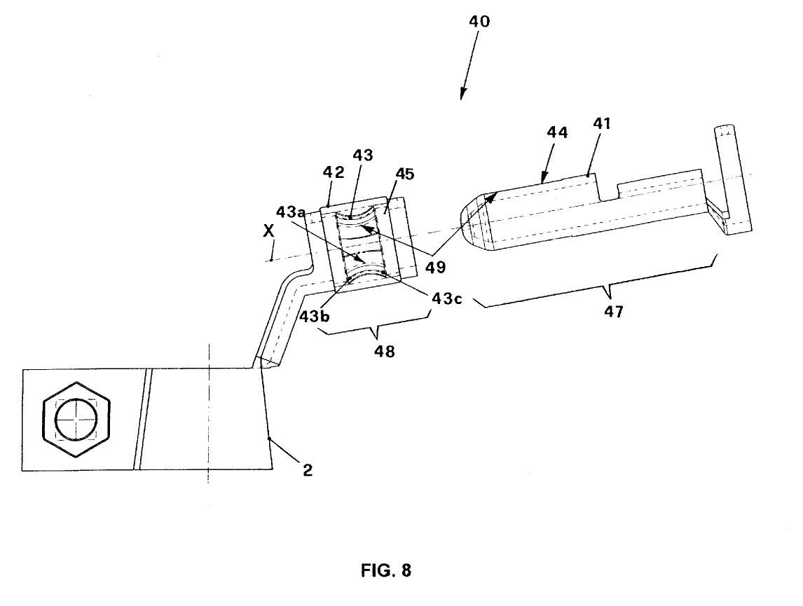

A further construction variant of the connection that is the subject of the invention is shown in FIG. 8, where it is indicated as a whole by 40 and differs from the embodiment just described due to a further different configuration of the contact means 49.

It can be noted, in fact, that the elastic tabs 43 have both ends 43b, 43c belonging to the tubular body 42 of the female connector element 48 and are arranged parallel to one another and circumferentially with respect to the longitudinal axis X defined by the tubular body 42.

According to the preferred embodiment of the invention described herein, the elastic tabs 43 are provided in a tubular sleeve 45 that is forced into the corresponding tubular body 42.

Both ends 43a and 43b of the elastic tabs 43 belong to the tubular sleeve 45.

In any case, in different embodiments of the invention the elastic tabs 43 can be created directly inside the tubular body 42.

They have a curved profile whose convex part 43a is directed towards the inside of the tubular body 42 and rest against the external surface 44 of the shaped core 41 of the male connector element 47, which in this case has a cylindrical profile and a substantially smooth surface.

It is important to point out that also the embodiments described and represented in FIGS. 7 and 8 may include construction variants in which the tubular body 32, 42 belongs to the wire C and the shaped core 31, 41 belongs to the clamp 2.

The construction variants illustrated in the Figures from 9 to 13 are also possible, in which the clamp 2 comprises various connector elements, indifferently of the female or male type or even combined, each one of which is coupled with a Corresponding connector element belonging to a wire C.

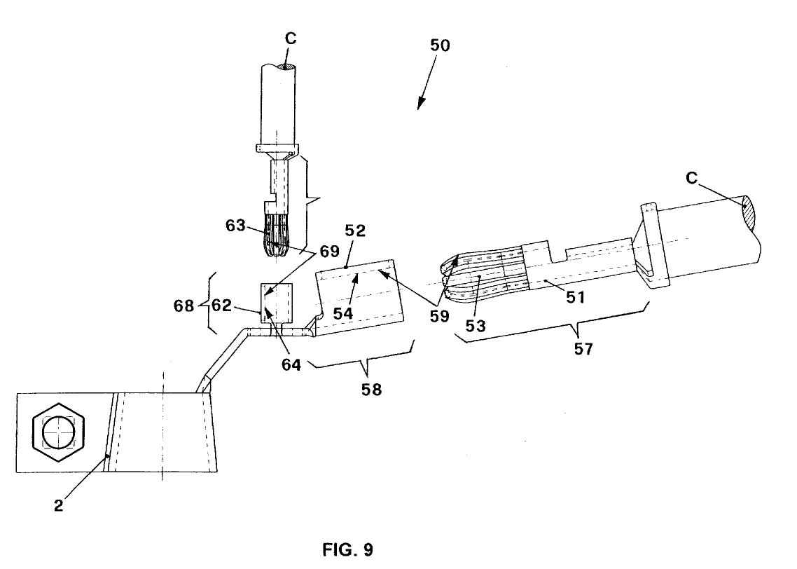

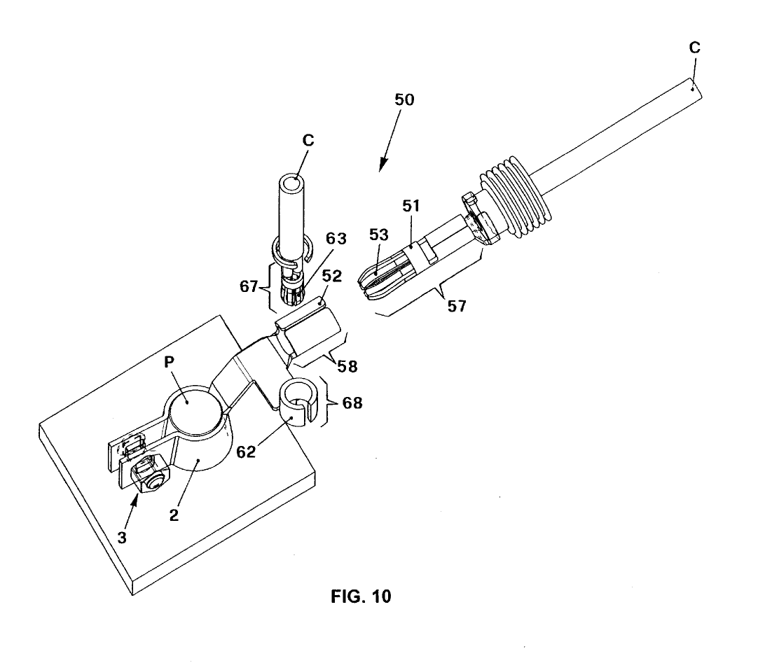

In this way, for example, FIGS. 9 and 10 show a construction variant of the connection that is the subject of the invention, indicated as a whole by 50, in which it is possible to observe that the clamp 2 comprises two female connector elements 58, 68, each one of which is coupled with a corresponding male connector element 57, 67 belonging to a corresponding wire C.

The contact means 59, 69 between each female connector element 58, 68 and each corresponding male connector element 57, 67 are of the type already described and comprise a plurality of elastic tabs 53, 63 with curved profile projecting from the male connector element 57, 67.

The internal surface 54, 64 of each corresponding tubular body 52, 62 of the female connector element 58, 68 has a cylindrical profile and a substantially smooth surface that is coupled with the elastic tabs 53, 63 to ensure electrical continuity and the mechanical contact.

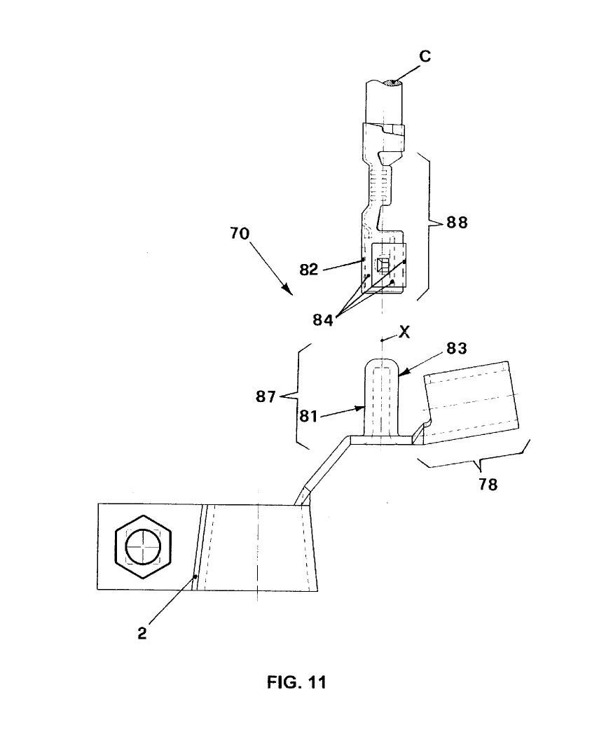

A further construction variant of the connection that is the subject of the invention is shown in FIG. 11, where it is indicated as a whole by 70 and differs from the embodiment just described in that the clamp 2 comprises a female connector element 78 and a male connector element 87, wherein the male connector element 87 is coupled with a corresponding female connector element 88, belonging to the wire C, which includes a tubular body 82.

The contact means between the male connector element 87 and the female connector element 88 comprise a plurality of shaped projections 84 made on the inner surface of the tubular body 82 parallel to the longitudinal axis X defined by it and the substantially smooth external cylindrical surface 83 of the shaped core 81 of the male connector element 87.

Also in this construction variant the coupling takes place through axial shifting and mutual insertion of the connector elements one inside the other.

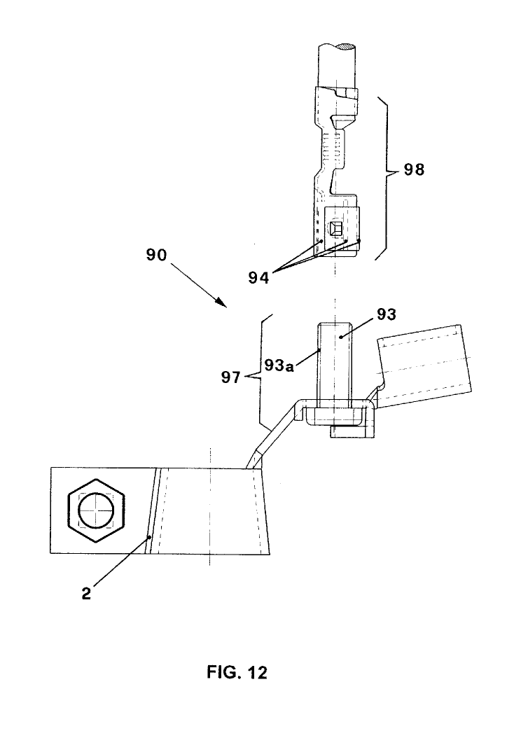

Another construction variant of the invention is shown in FIG. 12, where it is indicated as a whole by 90 and differs from the construction variant described above only in that the male connector element 97 belonging to the clamp 2 is a screw 93 whose thread 93a rests against the shaped projections 94 created on the inner surface of the tubular body 92 belonging to the female connector element 98.

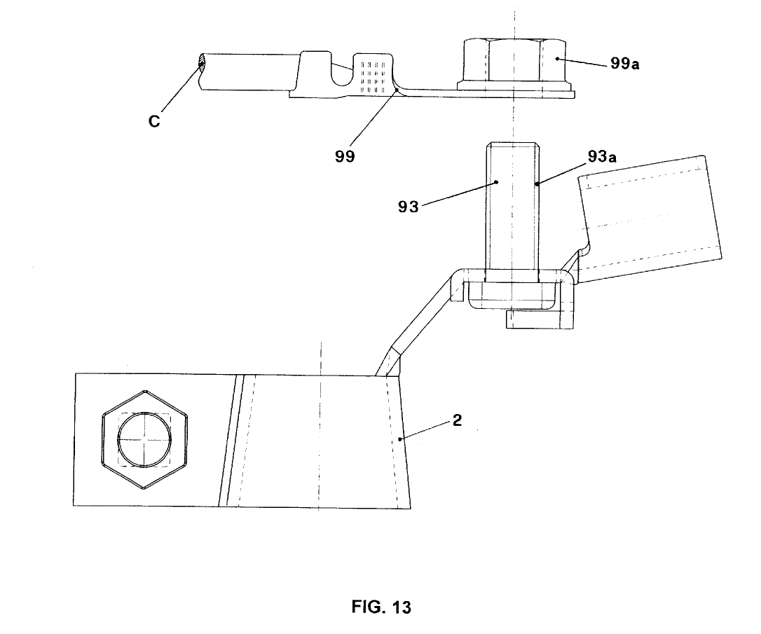

In this construction variant it is possible to constrain the wire C to the male connector element 97, which is constituted by the screw 93, via the wire terminal 99 with nut 99a as can be observed in FIG. 13.

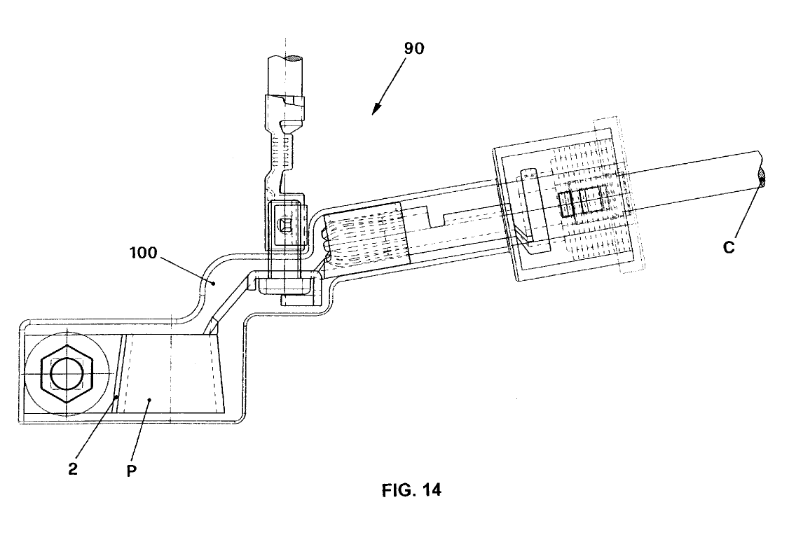

Also the connection elements of the construction variants comprising several wires connected to the same clamp can be provided with a covering in plastic material 100 in order to ensure protection against oxidation or the penetration of foreign matter in the connection itself; as shown in FIG. 14.

On the basis of what has been described, it can be seen that the connection that is the subject of the invention, in all the construction variants described, achieves the set objects.

In particular, the elimination of the screw means from the connection allows the user to connect and disconnect the wire to/from the clamp with no need to use special tools.

This obviously prevents any damage to the connection, which furthermore is also more economical to produce thanks to the elimination of the screws and corresponding nuts.

Finally, the connection that is the subject of the invention makes it possible to connect and disconnect the wire and the clamp in simpler and quicker way and these operations, above all, can be carried out even by unskilled operators.

The connection that is the subject of the invention thus results to be particularly useful if it is necessary to work in emergency conditions that require the immediate disconnection of the power supply to the various functions.

Obviously, in the construction phase the connector elements that create the connection may be subjected to changes that may consist especially of different profiles or shapes of the elements that carry out the mutual electrical connection.

Said changes or construction variants must all be considered protected by the present patent, provided that they fall within the scope of the claims expressed below.

1) Electrical connection comprising:
one clamp provided with means for fastening to the terminal of an electric accumulator;
at least one electric wire that connects said clamp to one or more functions;
means for joining said at least one electric wire to said clamp,
wherein said joining means comprise:
at least one male connector element;
at least one female connector element;
said connector elements being coupled to each other through contact means with quick coupling and release mechanism.

2) Electrical connection according to claim 1), wherein said at least one male connector element, said at least one female connector element and said contact means with quick coupling and release mechanism are coaxial to one another when they are coupled.

3) Electrical connection according to claim 1), wherein said at least one male connector element comprises a shaped core and said at least one female connector element comprises a tubular body that houses said shaped core, each shaped core being coupled with a corresponding tubular body through said contact means.

4) Electrical connection according to claim 1), wherein said male connector element belongs to said wire and said female connector element belongs to said clamp.

5) Electrical connection according to claim 1) wherein said male connector element belongs to said clamp and said female connector element belongs to said wire.

6) Electrical connection according to claim 1), wherein two or more connector elements belong to said clamp.

7) Electrical connection according to claim 6), wherein said connector elements comprise two female connector elements.

8) Electrical connection according to claim 6), wherein said connector elements comprise one female connector element and one male connector element.

9) Electrical connection according to claim 3), wherein said contact means comprise a plurality of elastic tabs with curved profile created in said shaped core and arranged parallel to the longitudinal axis defined by said shaped core, and wherein said elastic tabs rest against the inner surface of said tubular body.

10) Electrical connection according to claim 9), wherein said curved profile of each one of said elastic tabs has the convex part facing towards the outside of said shaped core to which it belongs and is placed in contact with said inner surface of said tubular body.

11) Electrical connection according to claim 9), wherein each one of said elastic tabs has one end belonging to said shaped core, while its opposite end is free.

12) Electrical connection according to claim 9), wherein each one of said elastic tabs has both ends belonging to said shaped core .

13) Electrical connection according to claim 3), wherein said contact means comprise a plurality of elastic tabs with curved profile created in said tubular body and arranged parallel to the longitudinal axis defined by said tubular body, and wherein said elastic tabs rest against the outer surface of said shaped core.

14) Electrical connection according to claim 13), wherein said curved profile of each one of said elastic tabs has the convex part facing towards the inside of said tubular body and is placed in contact with said outer surface of said shaped core.

15) Electrical connection according to claim 14), wherein each one of said elastic tabs with curved profile is created in said tubular body and has both ends belonging to said tubular body.

16) Electrical connection according to claim 14), wherein each one of said elastic tabs with curved profile is created in a tubular sleeve fixed to said tubular body and has both ends belonging to said tubular sleeve.

17) Electrical connection according to claim 3) wherein said contact means comprise a plurality of shaped projections created on the inner surface of said tubular body and arranged parallel to the longitudinal axis defined by said tubular body, and wherein said shaped projections rest against the outer cylindrical surface of said shaped core.

18) Electrical connection according to claim 3), wherein said contact means comprise a plurality of shaped projections created on the inner surface of said tubular body and arranged parallel to the longitudinal axis defined by said tubular body, and wherein said shaped projections rest against a thread present on the outer side surface of said shaped core.

19) Electrical connection according to claim 1), wherein each one of said connector elements belonging to said wire is provided with deformable clips for connection to said wire.

20) Electrical connection according to claim 18), wherein said deformable clips comprise first deformable clips for connection to the conductive core of said wire and second deformable clips for connection to the insulating sheath that covers said conductive core.

21) Electrical connection according to claim 1) wherein it comprises a covering made of an insulating material.
